(19) United States
(12) Patent Application Publication
(10) Pub. No.: US 2004/0224728 A1
(43) Pub. Date: Nov. 11, 2004

(54) Method and system for power save mode in wireless communication system

(75) Inventors: Behram Dacosta, San Diego, CA (US); David A. Desch, Poway, CA (US); Christopher J. Read, San Diego, CA (US)

Correspondence Address: ROGITZ & ASSOCIATES, 750 B Street, Suite 3120, San Diego, CA, 92101, US

(73) Assignees: SONY CORPORATION, Tokyo (JP); SONY ELECTRONICS INC., Park Ridge, NJ

(21) Appl. No.: 10/666,695

(22) Filed: Sep. 19, 2003

Related U.S. Application Data
(60) Provisional application No. 60/469,302, filed on May 9, 2003.

(51) Int. Cl. H04B 1/38

(52) U.S. Cl. 455/574; 455/572

(57) ABSTRACT

A user device enters a power save mode in which only the physical layer of its wireless communication system and minimal logic circuitry remains on. In a first implementation the minimal logic circuitry is in the MAC or the digital portion of the radio on a communication card, and the logic monitors the 802.11 traffic indication map (TIM) to determine whether traffic for the user device exists. If it does, the user is alerted or the device is powered on. In an optimum mode the minimal logic circuitry listens for a special sequence unique to the device, and if it detects the sequence leaves the power save mode.

### RELATED APPLICATIONS

This application claims priority from U.S. provisional patent application Ser. No. 60/469,302, filed May 9, 2003.

### I. FIELD OF THE INVENTION

The present invention relates generally to wireless digital communication systems.

### II. BACKGROUND OF THE INVENTION

In a wireless communication network that includes user devices such as laptop computers or personal digital assistants, standard IEEE 802.11 communication protocol typically is implemented using a communication card that is plugged into the user device to serve as a communication interface between the user device and a main node in the network referred to as an “access point”. Because many such user devices are battery operated in the absence of AC outlets, it is necessary to conserve battery power whenever feasible.

As recognized by the present invention, current power save modes in such applications are not very effective in saving power, because the devices must power on completely to listen for beacon frames from the access point, to see whether the beacon frames indicate that traffic for the device is available. Moreover, in both the low power mode and the wake up mode, the entire user device CPU as well as most of the card typically remain energized anyway, because most of the beacon packet processing is done by the user device, not the card. Even in cases where a separate CPU is embedded in the card, maintaining this CPU in a powered state to process beacon packets involves substantial power waste.

### SUMMARY OF THE INVENTION

A user device includes a host processor and a wireless communication interface module including a physical radio layer and wake up logic circuitry. The user device is configurable to enter a power save mode, wherein the host processor is deenergized and substantially only the physical radio layer and wake up logic circuitry remain energized in the user device. A wake up signal is generated upon detection by the wake up logic circuitry of a traffic signal from a wireless communication system node indicating that data for the device is available in the wireless communication system.

The wake up signal may be used to generate a user alert on the user device, or it may be used to automatically disable the power save mode to cause the host processor to be energized. The wake up logic circuitry may be implemented in the physical radio layer or in a medium access controller (MAC) on the module.

The wireless communication network may be a 802.11 network. In this embodiment, the traffic signal may be at least a portion of a 802.11-defined traffic indication map (TIM). In another embodiment, the traffic signal may include a special sequence of N bytes repeated M times, wherein N and M are integers, followed by an identification unique to the user device.

In another aspect, a user device that is configured for wireless communication with an access point of a wireless network includes a host processor having a power save mode in which the host processor is deenergized, and a physical radio layer configured for communicating with the wireless network and energized even when the host processor is in the power save mode. Wake up logic circuitry generates a wake up signal indicative of the availability of data for the user device in the network, with the wake up signal being generated upon receipt of a code from the network. The code is unique to the user device.

In still another aspect, an access point in a wireless network includes means for receiving a signal from a user device that the user device is entering a power save mode, with the access point transmitting a code useful in disabling the power save mode when data intended for the user device exists in the network.

In yet another aspect, a user device includes host processor means for processing data. The host processor means has an active mode, wherein the host processor means is energized, and a power save mode, wherein the host processor means is deenergized. Physical radio means are electrically connectable to the host processor means for communicating data from a wireless network thereto. The physical radio means remain energized when the host processor means is in the power save mode. Logic means receive information from the physical radio means for determining whether a wake up code has been received from a network node. This logic may be implemented independently of the physical radio means and an associated media access controller (MAC), or as part of one or both of the physical radio means and MAC.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram showing the present system;

FIG. 2 is a block diagram of the detailed architecture of the communication interface card;

FIG. 3 is a flow chart of the power save logic that can be implemented with minimal change to current 802.11 systems; and

FIG. 4 is a flow chart of optimal power save logic.

### DETAILED DESCRIPTION OF THE PREFERRED EMBODIMENT

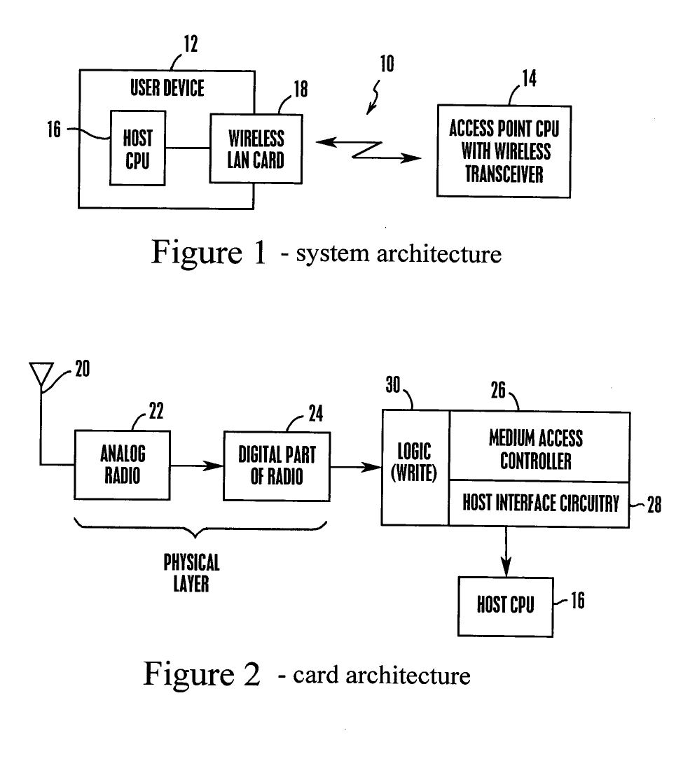

Referring initially to FIG. 1, a system is shown, generally designated 10, which includes a user device 12 that can communicate with one or more nodes 14 of a wireless network. The nodes may be access points or other user devices when the network is an IEEE 802.11 network. The user device 12 may be a laptop computer, personal digital assistant, or any other computing device such as a computer tablet or Web wireless TV. Moreover, while the present power save principles apply particularly to battery-powered wireless devices, the user device 12 may be a wired Ethernet device that can take advantage of the remote power-on features set forth further below. The user device 12 may communicate with the node 14 for any appropriate application, including videoconferencing.

As shown, the user device 12 includes a host processor 16. The host processor 16 communicates with the node 14 using a wireless radio. The wireless radio may be implemented within the host device 12 proper or as shown in FIG. 1 it may be implemented on a wireless LAN communication card 18 or other communication card that is selectively engageable with a card slot or port on the user device 12.

FIG. 2 shows the details of a preferred non-limiting implementation of the present radio as might be embodied in a removable 802.11 compliant card or other card. Radio signals are received from the node 14 and transmitted thereto over an antenna 20, which is connected to an analog radio portion 22 that may include one or more of a filter, an IF mixer, and a modulator/demodulator in accordance with radio principles known in the art. The radio may also include a digital part 24 which may include conversion circuitry between analog and digital formats and various digital radio components known in the art such as interleavers, etc. In some cases the digital part 24 may include the IF mixer and demodulator. Together, the analog and digital radio parts 22, 24 establish a physical radio layer (abbreviated “PHY”) of the user device 12.

Particularly for 802.11 applications, the radio may include a medium access controller (MAC) 26 that includes host interface logic circuitry 28 for communicating with the host processor 16. The MAC 26 may also include wake up logic circuitry 30 that receives data from the PHY layer 22, 24 and that functions in accordance with the logic below. It is to be understood that the wake up logic circuitry may be implemented in the digital part 24 of the radio. Owing to the simplicity of the below-described logic, the wake up logic circuitry 30 may comprise a relatively small part of the MAC 26, and may be implemented with a simple shift register and simple logic circuitry.

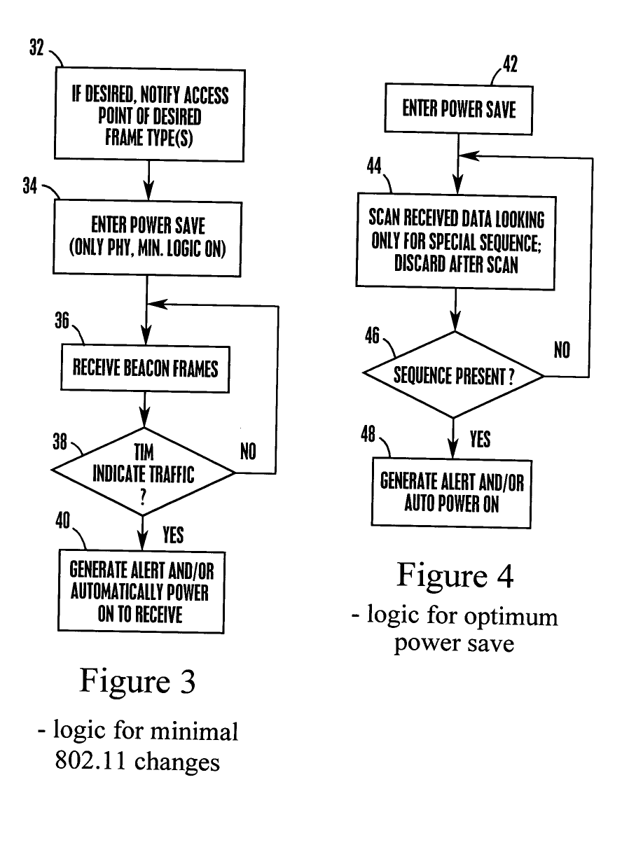

FIG. 3 illustrates example logic for effecting power savings without substantial change to existing IEEE 802.11 protocols. Commencing at block 32, if desired the user device 12 may inform the node 14 of the type of data (based on, e.g., user input) for which the user device 12 wishes to be awakened. For example, the user device 12 may wish to be awakened only for so-called “magic packets”.

Moving to block 34, the user device 12 enters the present power save mode. In the preferred power save mode, only the PHY 22, 24 and wake up logic circuitry 30 are energized. All other components of the user device 12, including the host processor 16 and its memory and portions of the MAC 26 including the host interface circuitry 28 that are not required to execute the present logic preferably are deenergized. The energized components can receive energy from the battery of the user device 12 or from an alternate power source, such as a small battery mounted on the card 18.

Proceeding to block 36, so-called 802.11 beacon frames are received by the PHY 22, 24 and sent to the wake up logic circuitry 30. These frames are not otherwise processed or retained beyond the test at decision diamond 38, which is simply to determine whether the traffic indication map (TIM) of the IEEE 802.11 Standard has set a bit that corresponds to the user device 12. If, at block 32, only certain types of data were indicated, the bit will be set only when these data types are available for the user device 12.

If the bit (which can be thought of as a code unique to the user device 12) is set, the node 14 is indicating that data exists in the network for the user device 12, and the logic moves to block 40. At block 40 a wake up signal is generated by the wake up circuitry 30. The wake up signal can be used either to generate a simple alert (e.g., a beep or LED light energization) on the user device 12, so that the user can decide whether to power up, or the signal can be used to energize the entire user device 12 automatically. The user device 12, upon disabling of the power save mode, is prepared to receive packets immediately, before the rest of the user device 12 is powered on. Or, the node 14 can deliver data only once the user device 12 requests the data. Upon power on from the power save mode the radio and MAC resume receiving power from the normal power supply, if a secondary supply is used during power save mode.

FIG. 4 shows alternate logic that can be used for optimum power savings. At block 42, the power save mode is entered upon, e.g., enabling a bit in a register or enabling an input line or other signal, and at block 44 data is scanned by the wake up circuitry 30 only for determining whether the data contains a code unique to the device 12. The data is not further processed or retained.

This code, which indicates that data traffic exists for the user device 12 in the network, may be a special sequence of N bytes repeated M times, wherein N and M are integers, followed by a device 12 identification.

As a non-limiting example, the code might be two bytes “FF” repeated three times, followed by an identification code unique to the user device 12. When this code is detected, the wake up signal is generated at block 48, causing a user alert to be generated or automatically energizing the user device 12, disabling the power save mode.

While the particular METHOD AND SYSTEM FOR POWER SAVE MODE IN WIRELESS COMMUNICATION SYSTEM as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. § 112, sixth paragraph, unless the element is expressly recited using the phrase “means for” or, in the case of a method claim, the element is recited as a “step” instead of an “act”. Absent express definitions herein, claim terms are to be given all ordinary and accustomed meanings that are not irreconcilable with the present specification and file history.

What is claimed is:

1. A user device, comprising:
a host processor; and
a wireless communication interface module including a physical radio layer and wake up logic circuitry not implemented by the host processor, the user device being configurable to enter a power save mode wherein the host processor is deenergized and substantially only the physical radio layer and wake up logic circuitry remain energized in the user device, a wake up signal being generated upon detection by the wake up logic circuitry of a traffic signal from a wireless communication system node indicating that data for the device is available in the wireless communication system.

2. The user device of claim 1, wherein the wake up signal is used to generate a user alert on the user device.

3. The user device of claim 1, wherein the wake up signal is used to automatically disable the power save mode to cause the host processor to be energized.

4. The user device of claim 1, wherein the wake up logic circuitry is implemented in the physical radio layer.

5. The user device of claim 1, wherein the wake up logic circuitry is implemented in a medium access controller (MAC) on the module.

6. The user device of claim 1, wherein the wireless communication network is a 802.11 network and the traffic signal is at least a portion of a 802.11-defined traffic indication map (TIM).

7. The user device of claim 1, wherein the traffic signal includes a special sequence of N bytes repeated M times, wherein N and M are integers.

8. The user device of claim 1, wherein the wake up logic circuitry is embodied at least in part by a shift register and related logic circuitry.

9. A user device configured for wireless communication with an access point of a wireless network, comprising:
a host processor having a power save mode in which the host processor is deenergized;
a physical radio layer configured for communicating with the wireless network and energized even when the host processor is in the power save mode; and
wake up logic circuitry generating a wake up signal indicative of the availability of data for the user device in the network, the wake up signal being generated upon receipt of a code from the network, the code being unique to the user device.

10. The user device of claim 9, wherein the wake up signal is used to generate a user alert on the user device.

11. The user device of claim 9, wherein the wake up signal is used to automatically disable the power save mode to cause the host processor to be energized.

12. The user device of claim 9, wherein the wake up logic circuitry is implemented in the physical radio layer.

13. The user device of claim 9, wherein the wake up logic circuitry is implemented in a medium access controller (MAC) on a communication module selectively engageable with the host processor.

14. The user device of claim 9, wherein the wireless network is a 802.11 network and the code is at least a portion of a 802.11-defined traffic indication map (TIM).

15. The user device of claim 9, wherein the code includes a special sequence of N bytes repeated M times, wherein N and M are integers, followed by a user device identification.

16. The user device of claim 9, wherein the wake up logic circuitry is embodied by a shift register.

17. An access point in a wireless network, comprising:
means for receiving a signal from a user device that the user device is entering a power save mode, the access point transmitting a code useful in disabling the power save mode when data intended for the user device exists in the network.

18. The network access point of claim 17, wherein the wireless network is a 802.11 network and the code is at least a portion of a 802.11-defined traffic indication map (TIM).

19. The network access point of claim 17, wherein the code includes a special sequence of N bytes repeated M times, wherein N and M are integers, followed by a user device identification.

20. A user device comprising:
host processor means for processing data, the host processor means having an active mode, wherein the host processor means is energized, and a power save mode, wherein the host processor means is deenergized;
physical radio means electrically connectable to the host processor means for communicating data from a wireless network thereto, the physical radio means remaining energized when the host processor means is in the power save mode; and
logic means receiving information from the physical radio means for determining whether a wake up code has been received from a network node.

21. The user device of claim 20, wherein the host processor means is a host processor, the physical radio means is a physical layer of a wireless radio, and the logic means is a wake up logic circuit.

22. The user device of claim 21, wherein the wake up code causes the generation of a user alert on the user device.

24. The user device of claim 21, wherein the wake up code causes automatically disabling of the power save mode.

25. The user device of claim 21, wherein the wake up logic circuit is implemented in the physical layer.

26. The user device of claim 21, wherein the wake up logic circuit is implemented in a medium access controller (MAC) on a communication module selectively engageable with the host processor.

27. The user device of claim 21, wherein the wireless network is a 802.11 network and the code is at least a portion of a 802.11-defined traffic indication map (TIM).

28. The user device of claim 21, wherein the code includes a special sequence of N bytes repeated M times, wherein N and M are integers, followed by a user device identification.

29. The user device of claim 21, wherein the wake up logic circuit is embodied by a shift register.
